(19) United States
(12) Patent Application Publication
(10) Pub. No.: US 2019/0150627 A1
(43) Pub. Date: May 23, 2019

(54) BED DEVICE

(71) Applicant: FRANCE BED CO., LTD., Tokyo (JP)

(72) Inventors: Kenzou WADA, Ehime (JP); Takashi ASAYAMA, Ehime (JP); Akihiro MIDORIKAWA, Tokyo (JP); Syunichi ISHIBASHI, Tokyo (JP)

(73) Assignee: FRANCE BED CO., LTD., Tokyo (JP)

(21) Appl. No.: 16/257,763

(22) Filed: Jan. 25, 2019

Related U.S. Application Data
(63) Continuation of application No. PCT/JP2017/025100, filed on Jul. 10, 2017.

(30) Foreign Application Priority Data
Jul. 28, 2016 (JP) 2016-148093

(51) Int. Cl. A47C 20/08; A61G 7/005; A61G 7/018; A61G 7/05

(52) U.S. Cl. CPC A47C 20/08; A61G 7/05; A61G 7/018; A61G 7/005

(57) ABSTRACT

A bed device comprises a bottom unit including a back bottom, a hip bottom, and a leg bottom connected to one another, and a drive mechanism capable of changing a posture of the bottom unit from a supine posture in which the back bottom, the hip bottom, and the leg bottom are aligned horizontally to a back lifting posture and a sitting posture. The drive mechanism allows the back bottom to stand up about the hip bottom in the change from the supine posture to the back lifting posture, and rotates the leg bottom around one end of the hip bottom and accommodates the leg bottom on a back side of the hip bottom in the change from the back lifting posture to the sitting posture.

### CROSS-REFERENCE TO RELATED APPLICATIONS

This application is a continuation of International Application No. PCT/JP2017/025100, filed on Jul. 10, 2017, which claims priority to and the benefit of Japanese Patent Application No. 2016-148093 filed on Jul. 28, 2016. The disclosures of the above applications are incorporated herein by reference.

### FIELD

The present disclosure relates to a bed device capable of changing a posture from a supine posture to a back lifting posture and from a back lifting posture to a rise assisting posture.

### BACKGROUND

The statements in this section merely provide background information related to the present disclosure and may not constitute prior art.

Conventionally, to assist change of the posture of elderly persons, persons with physical disabilities (hereinafter referred to as users) and the like on bed devices, bed devices provided with a back lifting function and a knee raising function have been developed.

For example, assistance to user's meal can be facilitated and assistance to a user rising from the bed devices can be facilitated by changing the back portion of the divided bottom to the back lifting posture by a mechanism for adjusting the same (Gatch mechanism). In addition, the user can be prevented from slipping forward to the foot side when lifting the back by adding a knee raising function to the back lifting function.

In other words, the user can be prevented from being bedridden and burden on a caregiver can be reduced by adding a function to assist the user's posture change to the bed device.

In addition, a bed device comprising the back lifting function alone, a bed device comprising the knee raising function in addition to the back lifting function, or a bed device comprising a function capable of transforming into a chair shape in addition to the back lifting function and the knee raising function, and the like exist. A bed device suited to user's physical conditions can be selected from these bed devices.

However, even if the user can purchase a bed device suited to the user's physical conditions, the user's physical conditions changes day by day, and may differ from the physical conditions at the time of purchase after several months or several years have passed. Then, a bed device according to the user's physical conditions needs to be purchased again, and the user's economic burden becomes large.

In addition, a bed device capable of changing the posture with less burden on the user's body is desired.

Thus, a multi-functional bed device capable of changing the posture with less physical burden on the user, similarly to, for example, JP 5658120 B, has been proposed.

The bed device of JP 5658120 B will be explained.

This bed device enables change of a plurality of postures by combining a plurality of links and using a driving means for each of the links. The posture can be thereby changed with less burden on the user.

According to the bed device disclosed in JP 5658120 B, however, a foot cannot be attached directly to the floor, in a chair position (sitting posture) as shown in FIG. 5. Therefore, the user uses a foot board when getting off the bed.

At this time, since no supporting member is arranged on the lower side of the foot board, the user's weight is applied to the foot board. The user must land once and get off the bed while paying attention to swinging with an unstable foothold, and the like.

In addition, at the chair position, a support arm is arranged perpendicularly to the bed device. As a result, as shown in FIG. 3 and the like, since the user's knee is very far away from the floor surface, there is a danger that the user falls accidentally. In addition, the bed device may give the user a feeling of fear.

### SUMMARY

An object of one aspect of the present disclosure is to enhance safety and convenience in a bed device which can be changed to a plurality of postures.

A bed device according to one embodiment comprises a bottom unit including a back bottom, a hip bottom, and a leg bottom connected to one another, and a drive mechanism capable of changing a posture of the bottom unit from a supine posture in which the back bottom, the hip bottom, and the leg bottom are aligned horizontally, to a back lifting posture and a sitting posture. The drive mechanism allows the back bottom to rise relative to the hip bottom in the change from the supine posture to the back lifting posture. In addition, the drive mechanism rotates the leg bottom around one end of the hip bottom and accommodates the leg bottom on the back side of the hip bottom in the change from the back lifting posture to the sitting posture.

The bed device may further comprise a side rail including an outer frame and an inner frame sliding inside the outer frame. The leg bottom may be pulled toward the head side of the bed device in accordance with the contraction of the side rail, and the leg bottom may be thereby accommodated on the back side of the hip bottom.

The bottom unit may further comprise a knee bottom disposed between the hip bottom and the leg bottom. In this case, the drive mechanism may rotate the knee bottom and the leg bottom around one end of the hip bottom and accommodate the knee bottom and the leg bottom on the back side of the hip bottom, in the change from the back lifting posture to the sitting posture.

In the sitting posture, the connecting portion between the hip bottom and the knee bottom may be located above the connecting portion between the back bottom and the hip bottom (knee lifting function). In addition, the knee bottom may be accommodated in the leg bottom, in the sitting posture.

The drive mechanism may be capable of changing the posture of the bottom unit from the sitting posture to the rise assisting posture. In this case, the drive mechanism may tilt the back bottom and the hip bottom toward the foot side of the bed device in the change from the sitting posture to the rise assisting posture.

In the bed device of the present invention, the leg bottom is accommodated on the back side of the hip bottom in the sitting posture, and the foot of the user M can land directly on the floor surface. The user can thereby safely execute the act of rising from the bed device.

In addition, the rise of the hip bottom can be minimized as much as possible in the change of posture from the back lifting posture to the sitting posture, by providing the knee bottom between the hip bottom and the leg bottom. The user's discomfort and physical burden such as pressing of the user's abdomen caused by the change of posture can be reduced. In addition, in the sitting posture, the bed device can be made compact since the knee bottom is accommodated on the back side of the hip bottom. Furthermore, in the sitting posture, the bed device can be made further compact since the knee bottom is accommodated in the leg bottom.

When changing from the supine posture to the back lifting posture, the user can be prevented from slipping forward by the knee lifting function. Thus, the user's bed sores can be prevented and the pressure applied to the user's buttocks can be reduced.

In addition, the user's posture is changed from the posture of sitting on the bed device to the half-rising posture in which the user raises the position of the buttocks and rises, by changing the posture of the bed device from the sitting posture to the rise assisting posture. The user M can thereby easily rise from the bed device.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter. Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a front view showing an entire body of a bed device 1.

FIG. 2 is a plan view showing the entire body of the bed device 1.

FIG. 3 is a front view for explanation of a combination of a base unit 2, an elevating unit 3, and an upper frame unit 4.

FIG. 4 is a plan view for explanation of a combination of a base unit 2, an elevating unit 3, and an upper frame unit 4.

FIG. 5 is a front view (a) and a plan view (b) for explanation of a fixed frame 51 of a drive mechanism 5.

FIG. 6 is a front view (a) and a plan view (b) for explanation of a cam mechanism 5A and a cam drive means 9 of the drive mechanism 5.

FIG. 7 is a front view (a) and a plan view (b) for explanation of a support frame 5B of the drive mechanism 5.

FIG. 8 is a front view (a) and a plan view (b) for explanation of a first link 56 of a link unit 5C of the drive mechanism 5.

FIG. 9 is a front view (a) and a plan view (b) for explanation of a second link 57 of the link unit 5C of the drive mechanism 5.

FIG. 10 is a front view (a) and a plan view (b) for explanation of a third link 58 of the link unit 5C of the drive mechanism 5.

FIG. 11 is a front view (a) and a plan view (b) for explanation of a shift mechanism 59 of the drive mechanism 5, and a plan view (c) showing a state in which the shift mechanism is contracted.

FIG. 12 is a front view (a) and a plan view (b) for explanation of a side frame 510 of the drive mechanism 5.

FIG. 13 is a front view showing a bottom unit 6.

FIG. 14 is a plan view showing the bottom unit 6.

FIG. 15 is a view showing a state in which the bottom unit 6 is changed to the back lifting posture by the operation of the drive mechanism 5.

FIG. 16 is a view showing a state in which the back lifting posture of the bottom unit 6 is changed to the sitting posture by the operation of the drive mechanism 5.

FIG. 17 is a view showing a state in which the bottom unit 6 is changed to the sitting posture by the operation of the drive mechanism 5.

FIG. 18 is a view showing a state in which the bottom unit 6 is changed to a rise assisting posture by the operation of the drive mechanism 5.

FIG. 19 is a front view showing a back lifting posture (a), a front view showing a sitting posture (b), and a front view showing a rise assisting posture (c), of the bed device 1.

FIG. 20 is another view showing the change of the bottom unit 6 from the supine posture to the sitting posture.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

### Embodiment 1

A bed device 1 of the present invention will be explained with reference to the drawings.

This bed device 1 comprises a base unit 2 configured to freely move in mainly back and forth and right and left directions, an upper frame unit 4 urged to laterally ascend and descend by an elevating unit 3 which is an X link mechanism to the base unit 2, a bottom unit 6 disposed on the upper frame unit 4, and a mat 7 placed on the bottom unit 6. The bottom unit 6 is divided into a plurality of parts, and the attitude is changed by a drive mechanism 5.

As shown in FIG. 2, a head side, a foot side, a left hand side, and a right hand side are defined based on the posture of the user in a supine posture on the bed device 1.

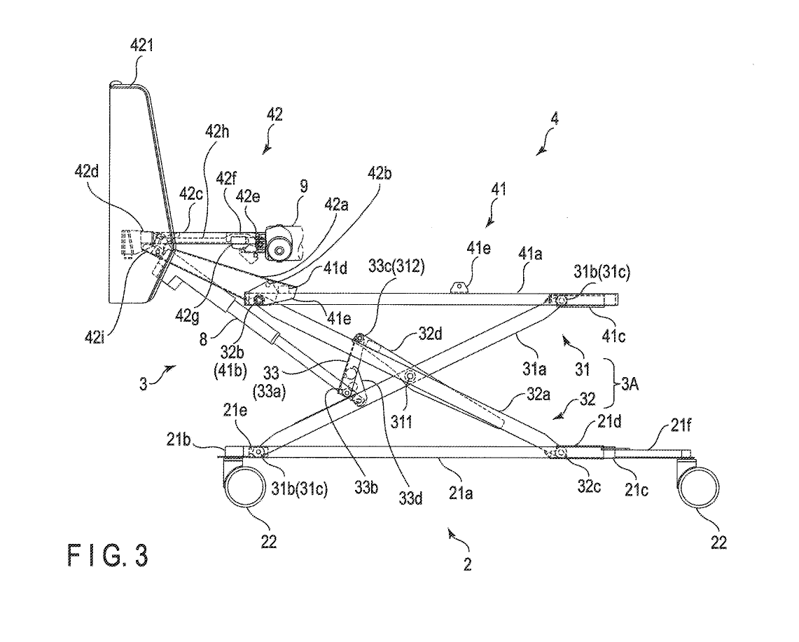

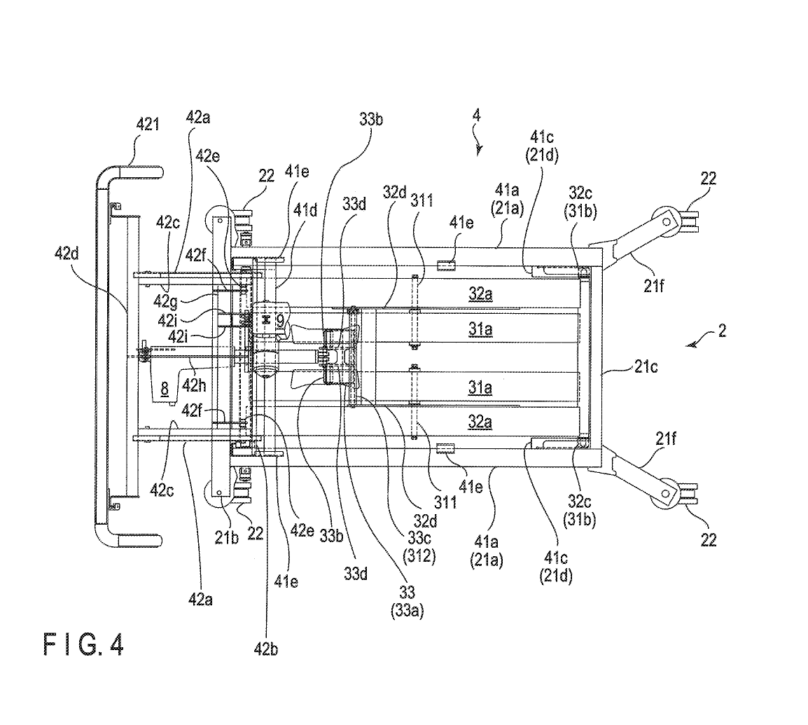

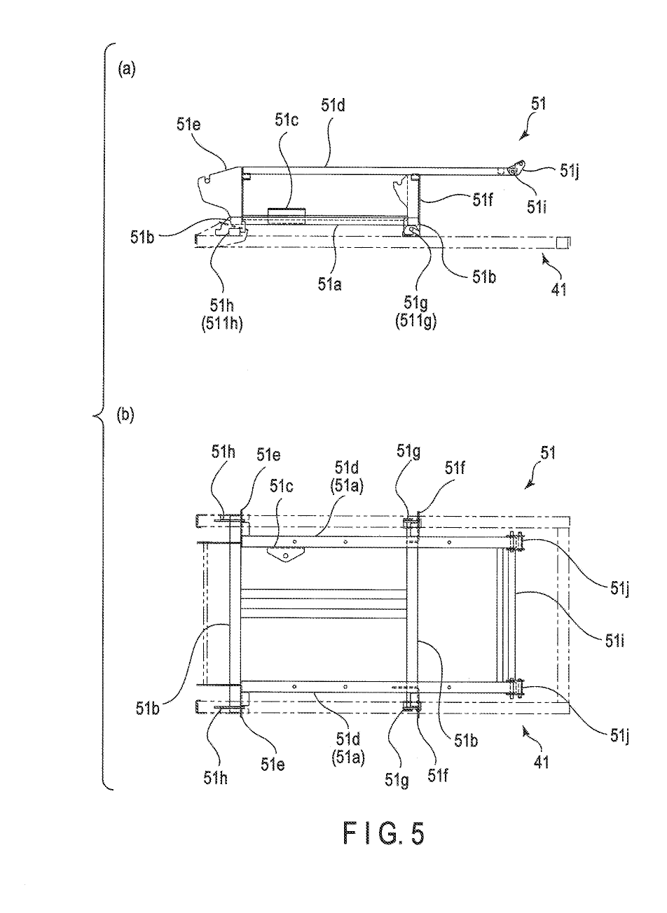

First, the base unit 2 will be explained. (The base unit 2, the elevating unit 3, and the upper frame unit 4 are shown in FIG. 3 and FIG. 4.)

The base unit 2 is configured to freely move back and forth and right and left with casters 22, 22, . . . attached to four corners of a base frame 21 formed in a substantially lattice shape as shown in FIG. 4.

More specifically, in the base frame 21, frame members 21b and 21c are provided at both ends of a pair of frame members 21a and 21a, support members 21d and 21d are provided near the right end of the frame members 21a and 21a, and support members 21e and 21e are provided near the left end thereof, respectively. Frame members 21f and 21f are provided at the right ends of the frame members 21a and 21a. Furthermore, casters 22, 22, . . . are provided at both ends of the frame member 21b and distal end sides of the frame members 21f and 21f, respectively.

Although the base unit 2 of the present embodiment comprises the casters 22, 22, . . . , and may be a stationary type in which a leg (not shown) or the like having an elastic body of rubber or the like attached tightly to its tip is arranged on the lower side of the base frame 21. In addition, the base unit 2 can be appropriately configured according to the usage environment of the user.

Next, the elevating unit 3 will be explained.

The elevating unit 3 comprises an elevating frame 3A configured in an X shape by a first elevating frame 31 and a second elevating frame 32, an auxiliary frame 33 axially supported by the elevating frame 3A so as to be rotatable, and an elevation drive means 8 (elevation drive mechanism) capable of extending and contracting. The elevation drive means 8 is connected to the auxiliary frame 33 and an upper frame unit 4 which will be explained later. The elevating frame 3A is opened and closed, and the upper frame unit 4, the driving mechanism 5, and the bottom unit 6 are urged to ascend and descend, by the expansion and contraction of the elevation drive means 8.

Furthermore, the elevating unit 3 will be explained in detail.

First, the first elevating frame 31 and the second elevating frame 32 constituting the elevating frame 3A will be explained. As shown in FIG. 4, the first elevating frame 31 comprises a pair of frame members 31a and 31a spaced apart from each other at a determined interval in the lateral direction, and a pair of support shafts 31b and 31b provided at both ends of the frame members 31a and 31a, respectively. Rollers 31c, 31c, . . . are provided at both ends of the support shafts 31b and 31b.

Next, as shown in FIG. 4, the second elevating frame 32 comprises a pair of frame members 32a and 32a spaced apart from each other at a predetermined interval in the lateral direction, boss members 32b and 32b provided at one-side ends of the frame members 32a and 32a, and a support shaft 32c provided at the other ends of the frame members 32a and 32a.

Connection plates 32d and 32d to which the auxiliary frame 33 is rotatably connected are provided on the inner sides of the frame members 32a and 32a.

Such a first elevating frame 31 is arranged inside the second elevating frame 32, the frame members 31a and 31a of the first elevating frame 31 and the frame members 32a and 32a of the second elevating frame 32 are rotatably connected by the shaft members 311 and 311, and the elevating frame 3A comprising an X link mechanism which is X-shaped as viewed from the front side is thereby constituted.

Next, the auxiliary frame 33 will be explained.

The auxiliary frame 33 comprises a substantially U-shaped plate 33a, a pair of rollers 33b and 33b axially supported at one end of the plate 33a, a boss member 33c provided at the other end of the plate 33a, and attachment plates 33d and 33d attached to a lower surface of the plate 33a. The boss member 33c of the auxiliary frame 33 and the connection plates 32d and 32d of the second elevating frame 32 are rotatably connected by a shaft member 312. One end of the elevation drive means 8 is connected to the attachment plates 33d and 33d.

In the present embodiment, the elevating unit 3 which is an X link mechanism is employed to urge the bottom unit 6 to ascend and descend in a perpendicular direction. However, as long as the elevating unit 3 can urge the bottom unit 6 to ascend and descend, it may be the other mechanism such as a parallel link mechanism (not shown).

Next, the upper frame unit 4 will be explained.

The upper frame unit 4 comprises a first upper frame 41 supported by the elevating unit 3 and a second upper frame 42 supporting the elevation drive means 8 and the drive mechanism 5.

As shown in FIG. 4, the first upper frame 41 comprises a pair of frame members 41a and 41a. Support shafts 41b and 41b for locking groove portions 421a and 421a of stay members 42a and 42a of a second upper frame 42 which will be explained later, are provided in the vicinity of one-side ends of the frame members 41a and 41a, and substantially U-shaped support members 41c and 41c which allow the support shafts 32c and 32c of the above-described elevating frame 3A to roll are provided in the vicinity of the other ends.

A support frame 41d is provided at the upper portion near the head side of the frame members 41a and 41a, and support plates 41e and 41e formed in a substantially U-shape are provided at central upper portions of the frame members.

The second upper frame 42 is configured by connecting one-side ends of two frames to be rotatable. More specifically, as shown in FIG. 4, the vicinities of one-side ends of the stay members 42a and 42a which are symmetrically formed and are spaced apart from each other at a determined interval are axially supported by a shaft member 42b. A support frame 42d for attaching a side frame 510 is provided at one-side ends of a pair of frame members 42c and 42c spaced apart from each other at a determined interval, and support shafts 42e and 42e for engaging with a fixing frame 51 of the drive mechanism 5 to be explained later are provided at the other ends. Substantially L-shaped rotating plates 42f and 42f are rotatably connected to the distal ends of the support shafts 42e and 42e.

A connection frame 42g is provided inside the support frames 42c and 42c near the support shafts 42e and 42e. Furthermore, a locking plate 42h and stays 42i and 42i are provided between the support frame 42d and the connection frame 42g.

One end of the elevation drive means 8 is rotatably connected to the locking plate 42h, and one end of a cam drive means 9 (cam drive mechanism) which will be described later is rotatably connected to the stays 42i and 42i.

One-side ends of the stay members 42a and 42a and one-side ends of the support frames 42c and 42c are rotatably connected, and the groove portions 421a and 421a of the stay members 42a and 42a are locked by the above-mentioned support shafts 41b and 41b.

Actuators are used as the elevation drive means 8 and the cam drive means 9 which will be described later in the present embodiment. However, the elevation drive means 8 may have the other configuration as long as it is configured to urge the bottom unit 6 to ascend and descend, and the cam driving means 9 may have the other configuration as long as it is configured to drive the drive mechanism 5 such that the posture of the bottom unit 6 can be changed.

According to the elevating unit 3 and the elevation drive unit 8 thus configured, the elevating frame 3A is opened and closed by expansion and contraction of the elevation drive unit 8, and the upper frame unit 4, the drive mechanism 5, and the bottom unit 6 ascend from and descend to the base unit 2.

In addition, since the elevating unit 3 is arranged inside the base part 2 and configured to ascend and descend, the elevating unit 3 can be accommodated in a compact shape in the lowest position.

Next, the drive mechanism 5 for operating the bottom unit 6 will be explained.

As shown in FIG. 5 to FIG. 12, the drive mechanism 5 comprises a fixed frame 51 placed on the upper frame unit 4, a cam mechanism 5A and a shift mechanism 59 which are operated by expansion and contraction of the cam drive means 9, a support frame 5B placed on the fixed frame 51, a link unit 5C (56, 57, 58) connected to the support frame 5B and interlocking with the bottom unit 6, and a side frame 510.

Each component of the drive mechanism 5 will be described in detail below.

First, the fixed frame 51 will be explained.

As shown in FIG. 5, a pair of frame members 51b and 51b are connected to both ends of a pair of frame members 51a and 51a. Further, a substantially U-shaped support bracket 51c is attached to the frame member 51a. Frame members 51d and 51d longer than the frame members 51a and 51a are arranged parallel to the frame members 51a and 51a. The frame members 51a and 51a and the frame members 51d and 51d are connected via connection plates 51e, 51e, 51f and 51f bent in an L shape.

Locking plates 51g and 51g including grooves 511g and 511g locking with the upper frame unit 4 are provided at both ends of the frame member 51b located on the head side. Locking plates 51h and 51h including grooves 511h and 511h locking with the upper frame unit 4 are provided at both ends of the frame member 51b located on the foot side.

A rod member 51i extending in a direction perpendicular to the frame members 51d and 51d is arranged at one-side ends of the frame members 51d and 51d. Substantially U-shaped brackets 51j and 51j are provided at both ends of the rod member 51i. The rod member 51i is rotatably connected to the frame members 51d and 51d via these brackets 51j and 51j.

Next, the details of the cam mechanism 5A will be explained.

The cam mechanism 5A comprises a first cam mechanism 52 operated by expansion and contraction of the cam drive means 9, and a second cam mechanism 53 urged by the operation of the first cam mechanism 52.

First, the first cam mechanism 52 will be explained.

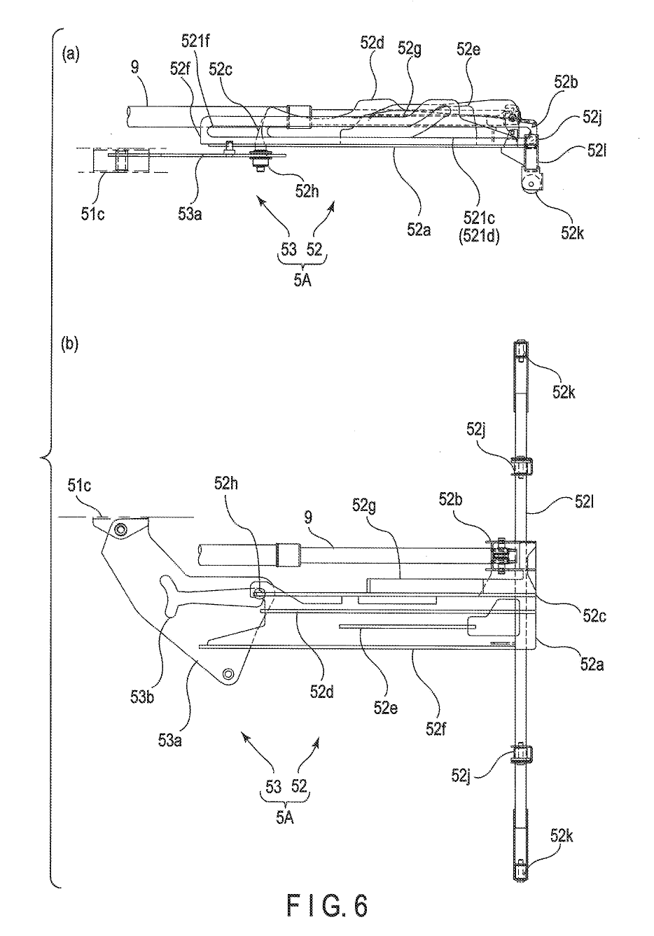

As shown in FIG. 6, a substantially U-shaped bracket 52b, a cam plate 52c for hip, a cam plate 52d for back, a cam plate 52e for knee, and a cam plate 52f for erection are connected to each other at regular intervals, in order from the left side, above a substantially L-shaped first base member 52a in planar view.

One end of the cam drive means 9 is connected to the bracket 52b. The above-described second upper frame 42 is connected to the other end of the cam drive means 9. The cam plate 52c for hip and the cam plate 52d for back are provided with long holes 521c and 521d of the same shape, respectively. The cam plate 52f for erection is provided with a long hole 521f which is bent to an upper right side when viewed from the front side.

As will be described later in detail, the upper surface of each of the cam members has an irregular shape, and the cam mechanism is configured such that rollers of the driving mechanism 5 and the bottom unit 6 to be explained later roll on the upper surface and the bottom unit 6 can thereby change the posture.

A switch support plate 52g having a shape bent in a front view is connected to the upper vicinity of the bracket 52b and the cam plate 52c for hip. An urging shaft 52h is connected to a lower part of the first base member 52a. A rolling support frame 521 is connected to the first base member 52a. Rollers 52j and 52j for supporting a side frame 510 to be explained later are rotatably provided at both ends of the rolling support frame 521. Furthermore, rollers 52k and 52k which can roll above the frame members 41a and 41a of the first upper frame 41 are provided on the rolling support frame 521.

Next, the second cam mechanism 53 will be explained.

As shown in FIG. 6, one end of the second base member 53a is rotatably connected to the support bracket 51c of the fixed frame 51, and the other end is rotatably connected to the urging shaft 52h. The second base member 53a has a bent shape as a whole and includes a substantially Y-shaped groove 53b through which the urging shaft 52h of the first cam mechanism 52 is slidably inserted. Furthermore, one end of a connection frame 59k of a shift mechanism 59 to be explained later is rotatably connected to the second base member 53a.

Next, the support frame 5B will be explained.

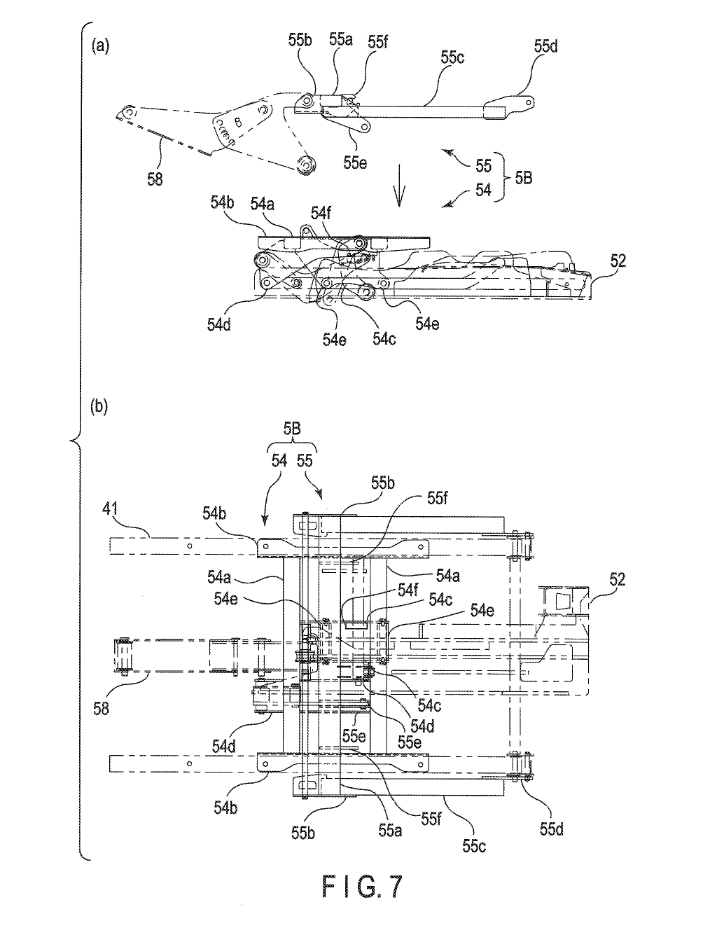

As shown in FIG. 7, the support frame 5B comprises a first support frame 54 placed on the fixed frame 51 and a second support frame 55 placed on the first support frame 54.

First, the first support frame 54 will be explained.

As shown in FIG. 7, substantially L-shaped brackets 54b and 54b are attached to both ends of a pair of frame members 54a and 54a. A pair of support plates 54c and 54c and a pair of support plates 54d and 54d connect the frame members 54a and 54a. First rolling shafts 54e and 54e are connected to the support plates 54c and 54c. The first rolling shafts 54e and 54e roll in the above-described long holes 521c and 521d provided in the cam plate 52c for hip and the cam plate 52d for back of the cam mechanism 5A.

In addition, a limit switch 54f is provided on the support plate 54c. The limit switch 54 f slides on the switch support plate 52g during operation to be explained later. A first roller 56c of a first link 56 of a link unit 5C to be explained later is axially supported on the support plates 54d and 54d so as to be capable of rolling on the upper surface of the cam plate 52f for erection.

Next, the second support frame 55 will be explained.

As shown in FIG. 7, the second support frame 55 comprises a connection frame 55a placed on the first support frame 54, and side frame brackets 55b and 55b connected to both ends of the connection frame 55a to tighten a side frame 510 to be explained later. A pair of frame members 55c and 55c which are arranged in the lateral direction from the lower side of the side frame bracket 55b and to which the stays 55d and 55d are fixed are connected to the connection frame 55a and the side frame brackets 55b and 55b.

One-side ends of frame members 51d and 51d of the fixed frame 51 are connected to the stay 55d and 55d. Fulcrum plates 55e and 55e for axially attaching one end of a first link to be explained later, and latch plates 55f and 55f for axially attaching a hip bottom 62 to be explained later so as to be rotatable, are connected to the connection frame 55a.

Next, the link unit 5C will be explained.

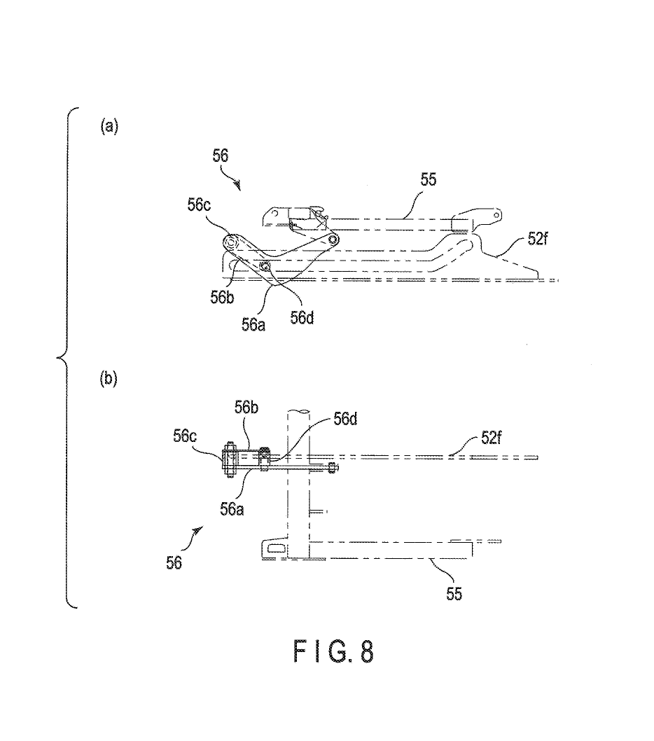

The link unit 5C is composed of three link mechanisms. That is, as shown in FIG. 8 to FIG. 10, the link unit 5C comprises a first link 56 and a third link 58 axially attached to the first support frame 54 so as to be rotatable, and a second link 57 axially attached to the second support frame 55 so as to be rotatable.

First, the first link 56 will be explained.

As shown in FIG. 8, the first link 56 comprises a plate member 56a having a bent shape, a plate member 56b having a length which is approximately half the length of plate member 56a, and a first roller 56c and a second rolling shaft 56d which axially support the plate members 56a and 56b. One end of a plate member 56a is rotatably connected to the fulcrum plates 55e and 55e of the second support frame 55.

The first link 56 having such a structure is assembled so as to be interlocked with the first cam mechanism 52 and the first support frame 54 described above.

Next, the second link 57 will be explained.

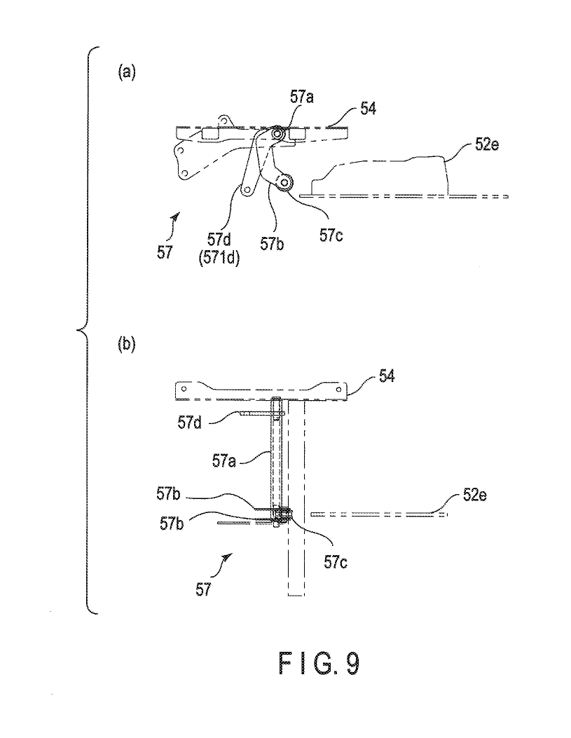

As shown in FIG. 9, the second link 57 comprises a hollow boss member 57a, substantially U-shaped support plates 57b and 57b provided at one end of the boss member 57a, and a second roller 57c axially supported between the support plates 57b and 57b. A support plate 57d is connected to the other end of the boss member 57a such that a groove 571d is arranged slightly below a position connecting the centers of the boss member 57a and the second roller 57c in a straight line (approximately 40 degrees in the present embodiment).

The second link 57c thus configured is axially supported so as to be rotatable by arranging the boss member 57a between the bracket 54b of the first support frame 54 and the support plate 54d. Furthermore, the second roller 57c is configured to roll on the upper surface of the cam plate 52e for knee. The support plate 57d engages one end of a bottom connection rod 65g to be explained later with the groove 571d.

Next, the third link 58 will be explained.

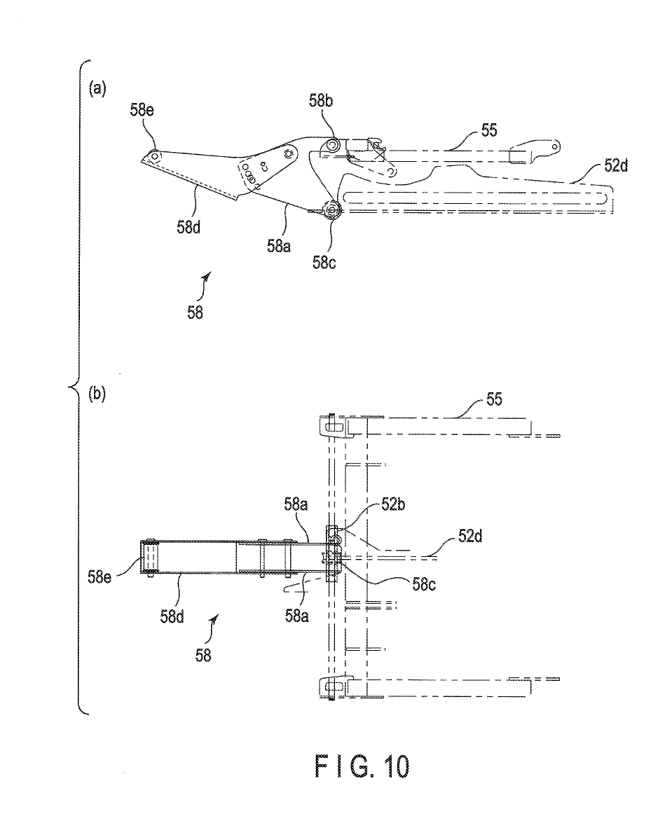

As shown in FIG. 10, the third link 58 comprises two plate members 58a and 58a having a bent shape when viewed from the front side, a boss member 58b connected to one-side ends of the plate members 58a and 58a, and a third roller 58c axially supported at the other ends of the plate members 58a and 58a. A substantially U-shaped bracket 58d is rotatably connected to the outside of the plate members 58a and 58a.

The third link 58 is configured such that the third roller 58c rolls on the upper surface of the cam plate 52d for back of the first cam mechanism 52 by axially attaching the boss member 58b to the support plate 54c of the first support frame 54 so as to be rotatable. A support roller 58e is axially attached to one end of the bracket 58d so as to be capable of pivoting, and allows a slidable member 61f of the back bottom 61 to be explained later to roll.

Next, the shift mechanism 59 will be explained.

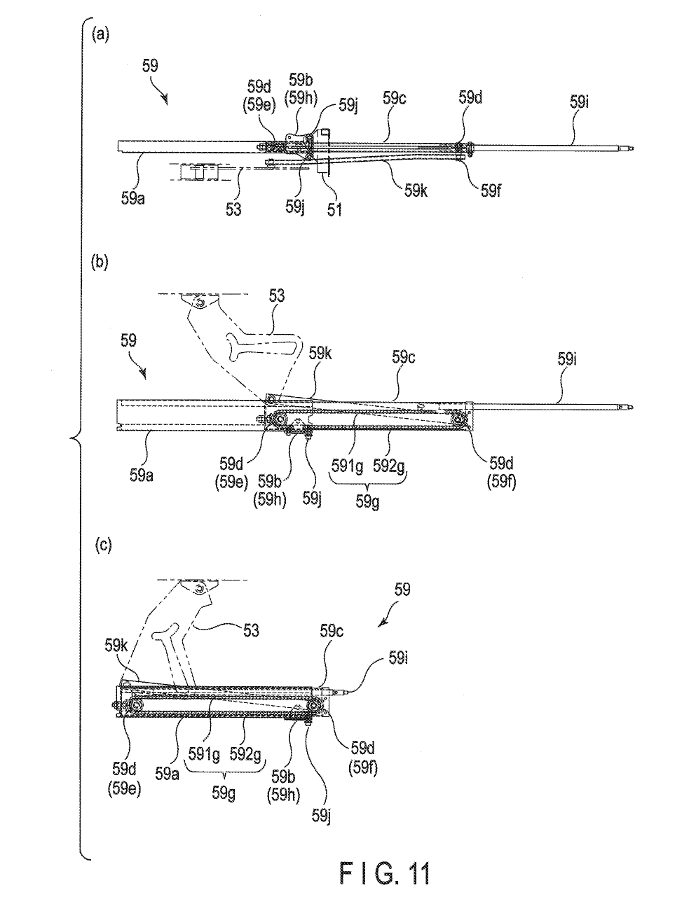

As shown in FIG. 11, the shift mechanism 59 comprises an outer frame 59a having a substantially lip groove shape, a support plate 59b provided at one end of the outer frame 59a, an inner frame 59c inserted into the inner side of the outer frame 59a. A slidable member (not shown) is provided on the outer periphery of the inner frame 59c so as to be slidable inside the outer frame 59a. A bracket 59e to which a sprocket 59d is rotatably attached is screwed to one end of the inner frame 59c so as to adjust the tension of an operation chain 59g to be explained later. A sprocket 59d inserted from the outside of the inner frame 59c is rotatably attached to the vicinity of the other end of the inner frame 59c by a support shaft 59f.

An operation chain 59g is stretched in a loop shape, on the sprockets 59d and 59d. More specifically, the operation chain 59g is composed of a first chain 591g and a second chain 592g having substantially equal lengths, and a connection stay 59h and a rod member 59i are attached to both ends of a first chain 591g and a second chain 592g, respectively.

The connecting stay 59h is fixed to the supporting plate 59b of the above-described outer frame 59a by pins 59j and 59j and is connected to the fixed frame 51. The tip of the rod member 59i is attached to the third leg frame 69 of a leg bottom 66 to be explained later. The inner frame 59d is formed in a box shape by overlapping two U-shaped plates, and after the parts arranged inside the above-explained inner frame 59d are assembled, they are fixed by screws.

The connection frame 59k is arranged between the shift mechanism 59 and the second cam mechanism 53 of the cam mechanism 5A and attached to the support shaft 59f of the shift mechanism 59 and one end of the second base member 53a of the second cam mechanism 53, and the shift mechanism 59 and the second cam mechanism 53 are thereby configured to be interlocked with each other.

Next, a side frame 510 will be explained.

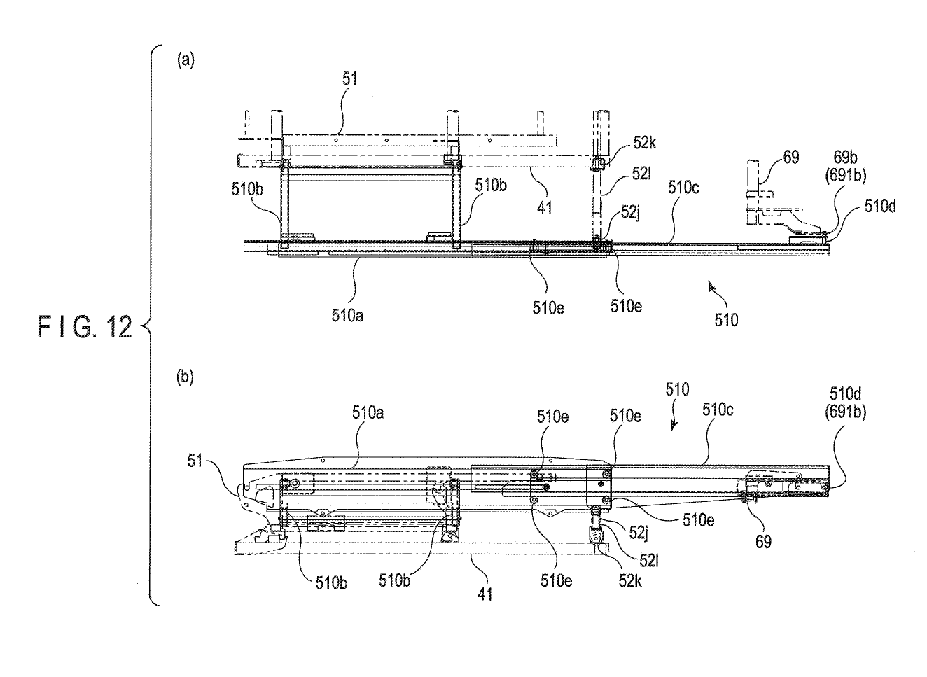

As shown in FIG. 12, the side frame 510 is attached to the fixed frame 51 and the second support frame 55 described above, and is connected to a leg bottom 66 to be explained later. Since the side frame 510 has a symmetrical shape, as shown in FIG. 12, its configuration will be explained while focusing on the side frame 510 on the user's right hand side.

Connection frames 510b and 510b spaced apart from each other by a predetermined distance are attached to an outer frame 510a formed by bending a plate into a rectangular shape. An inner frame 510c is arranged to be slidable in the outer frame 510a. A support shaft 510d for engaging with a third leg frame 69 of a leg bottom 66 to be explained later is provided at one end of the inner frame 510c.

A plurality of rollers 510e, 510e, . . . are arranged between the inner frame 510c and the inner side of the outer frame 510a. In addition, an elastic body (a tension spring not shown) is stuck between one end side of the inner frame 510c to which the support shaft 510d is not fixed and the outer frame 510a. The outer frame 510a and the inner frame 510c can thereby slide smoothly.

A side board 510f is attached to the outer side of the outer frame 510a.

As described above, the link mechanism 5C, the shift mechanism 59, and the cam drive means 9, which are driven by the cam mechanism 5A, are combined with the driving mechanism 5 so as to interlock. Thus, the posture of the bottom unit 6 to be explained later can be changed by the only expansion and contraction of the cam drive means 9.

In addition, the cam drive means 9 can be made to extend in a half length at the extension and contraction, with the configuration of the shift mechanism 59 in the present embodiment. A space for accommodating the leg bottom 66 to be explained later can be thereby secured.

Furthermore, when combining the link unit 5C with the first cam mechanism 52, the first and second rolling shafts and the like roll in the long holes of the respective cam plates. Thus, when the cam mechanism 5A moves during an operation to be explained later, the load applied to the bottom unit 6 can be dispersed and received by the support frame 5B and the link unit 5C. For this reason, the durability of the cam mechanism 5A is improved.

In addition, a slidable member (not shown) is desirably arranged between the components when combining the components constituting the drive mechanism 5. Thus, in an operation of the drive mechanism 5 to be explained later, displacement of the components can be suppressed and the drive mechanism can be operated stably.

An example of the drive mechanism capable of reducing the costs and making the body size as small as possible has been explained, but the drive mechanism may comprise the other configuration.

For example, the posture of the bottom unit may be changed to an arbitrary posture by directly connecting the drive means (actuator) between the bottoms constituting the drive mechanism 5 and the bottom unit 6 instead of the cam mechanism 5A, the support frame 5B, and the link unit 5C.

In addition, the side frame 510 may be configured such that the leg bottom 66 can be pulled toward the head side by using the drive means (actuator) for the side frame 510 and directly connecting the drive means to the leg bottom 66 of the bottom unit 6 to be explained later.

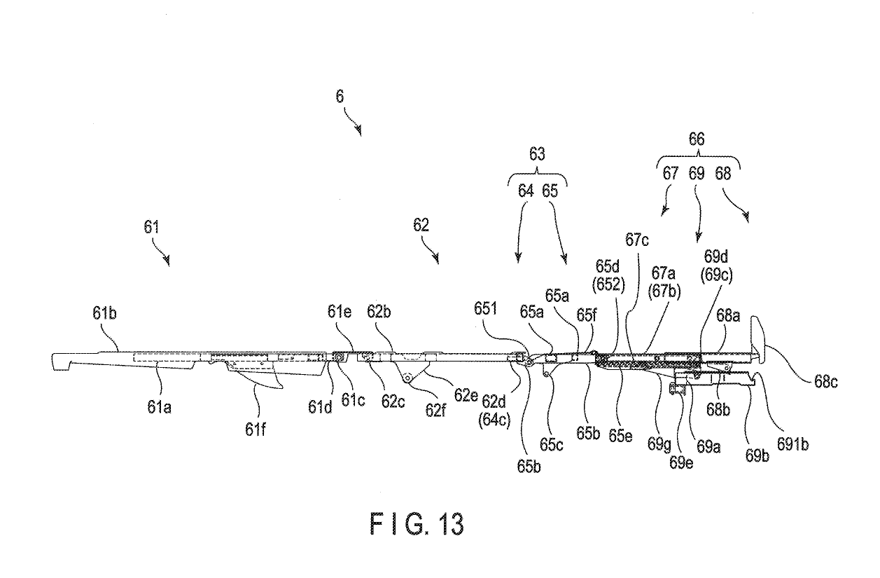

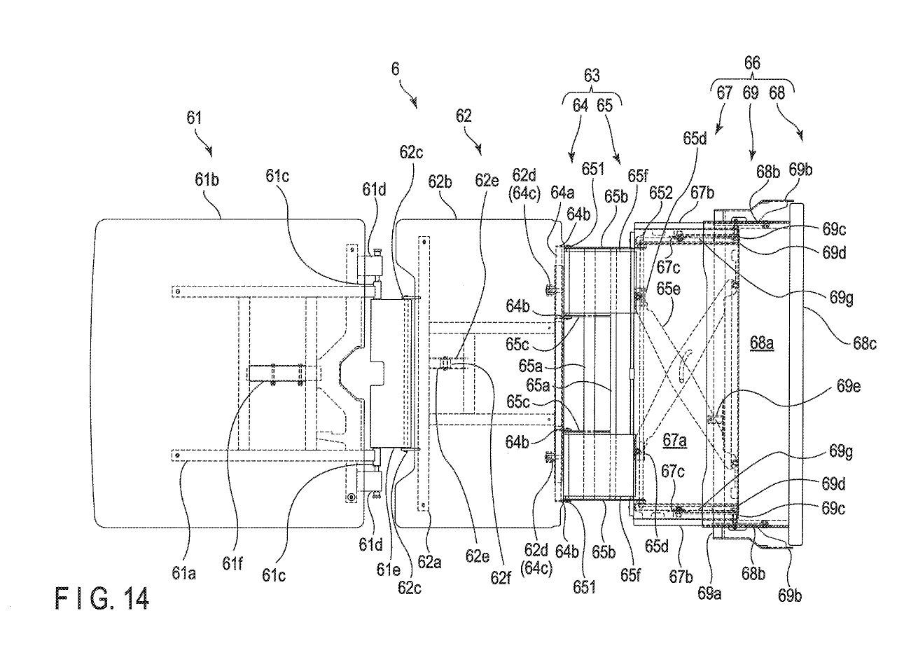

Next, the bottom unit 6 will be explained. As shown in FIG. 13 and FIG. 14, the bottom unit 6 is composed of the back bottom 61, the hip bottom 62, the knee bottom 63, and the leg bottom 66, which are divided into four bottoms. It should be noted that the knee bottom 63 can also be regarded as a part of the leg bottom 66.

First, the back bottom 61 will be explained.

As shown in FIG. 14, the back bottom 61 comprises a back bottom frame 61a composed of a plurality of frame members fixed to one another, and a resin-made back board 61b attached to the back bottom frame 61a. Boss members 61c and 61c and brackets 61d and 61d are provided at one end of the back bottom frame 61a. A connection plate 61e connecting the back bottom 61 and the hip bottom 62 is axially supported between the boss members 61c and 61c so as to be rotatable. As shown in FIG. 13, a resin-made slidable member 61f formed in a substantially J shape in a front view is mounted substantially at the center of the back bottom frame 61a.

Next, the hip bottom 62 will be explained.

Similarly to the above-described back bottom 61, the hip bottom 62 comprises a hip bottom frame 62a composed of a plurality of members fixed to one another and a resin-made hip board 62b attached to the hip bottom frame 62a. Support plates 62c and 62c are provided at one end of the hip bottom frame 62a. The connection plate 61e is axially supported between the supporting plates 62c and 62c so as to be rotatable. Boss members 62d and 62d for connecting a knee bottom 63 to be explained later are provided on the other end of the hip bottom frame 62a. A fourth roller 62f is provided between support plates 62e and 62e at substantially the center of the hip bottom frame 62a. The fourth roller 62f is capable of rolling on the upper surface of the cam plate 52c for hip of the above-described first cam mechanism 52.

Next, the knee bottom 63 will be explained.

The knee bottom 63 comprises a first knee frame 64 connected to the hip bottom 62 and a second knee frame 65 connected to the leg bottom 66. Each of the frames 64 and 65 is rotatably connected to each other.

As shown in FIG. 14, the first knee frame 64 comprises one frame 64a, four fulcrum plates 64b, 64b, . . . provided on the frame 64a and spaced apart at regular intervals, and support shafts 64c and 64c provided between the fulcrum plates 64b, 64b, . . . . The support shafts 64c and 64c are inserted through the frame 64a and the boss members 62d and 62d of the hip bottom 62, and the frame 64a is thereby attached to the hip bottom 62.

As shown in FIG. 14, the second knee frame 65 comprises two frame members 65a and 65a spaced apart from each other at regular intervals, and fulcrum plates 65b and 65b attached to both ends of the frame members 65a and 65a and formed in a substantially V shape in a front view. Fulcrum plates 65c and 65c are fixed to both outer sides of the fulcrum plates 64b and 64b of the first knee frame 64.

The fulcrum plates 64b and 64b of the first knee frame 64 having such a configuration and the fulcrum plates 65c and 65c of the second knee frame 65 are rotatably connected by shaft members 651 and 651.

Resin-made slidable members 65d and 65d are arranged between the fulcrum plates 65b and 65b. The slidable members 65d and 65d are mounted so as to be axially slidable by a shaft member 652. One end of an X-link arm 65e is connected to each of the slidable members 65d and 65d. Each X-link arm 65e is configured to be rotatable with respect to each other by axially attaching the center. It should be noted that the other end of the X-link arm 65e is connected to a first leg frame 67 to be explained later.

Cloth covers 65f and 65f are attached to one-side ends of the second knee frame 65 and the first leg frame 67 of the leg bottom 66. The covers 65f and 65f serve as structural members which support not only the prevention of pinching due to the sag of the mat 7 but also the change of posture of the leg bottom 66.

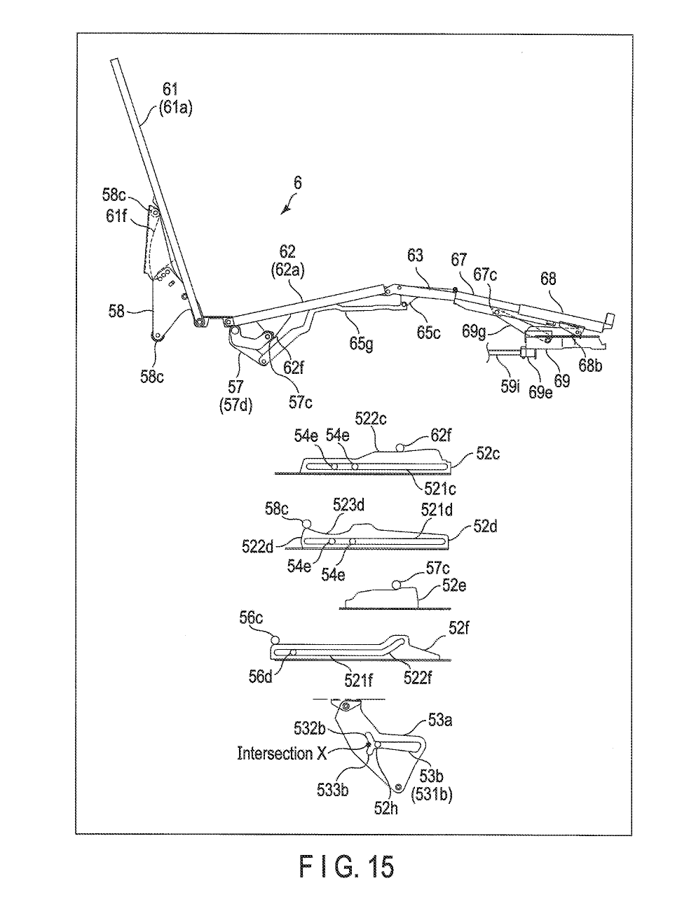

As shown in FIG. 15, a bottom connection rods 65g having a substantially V shape in a front view is axially attached to each of the fulcrum plate 65c and the support plate 57d of the second link 57. It should be noted that the bottom connection rod 65g has such a shape that there is no interference with each of the components at the posture change to be explained later.

Next, the leg bottom 66 will be explained.

The leg bottom 66 comprises a first leg frame 67 in which the second knee frame 65 of the knee bottom 63 can slide, a second leg frame 68 arranged to slide on the outside of the first leg frame 67, and a third leg frame 69 fastened to the shift mechanism 59. The first leg frame 67 can accommodate the second knee frame 65.

As shown in FIG. 14, the first leg frame 67 is provided with a frame member 67a bent in a U shape opening downward. The X-link arm 65e of the second knee frame 65 is connected to one end of the frame member 67a. Slash members 67b and 67b are attached to both side ends of the frame member 67a such that the second leg frame 68 can slide smoothly. Fulcrum plates 67c and 67c are attached to the inside of the side portion of the frame member 67a.

As shown in FIG. 14, the second leg frame 68 is arranged so as to be slidable on the outside of the first leg frame 67. A frame member 68a which is larger than the entire width of the first leg frame 67 and has a substantially lip groove shape is inserted through the first leg frame 67. Fulcrum plates 68b and 68b are provided near both ends of the lower surface of the frame member 68a. A foot board 68c is attached to one end of the second leg frame 68.

As shown in FIG. 14, the third leg frame 69 is axially attached to the second leg frame 68 so as to be rotatable, and is connected to each of the rod member 59i of the shift mechanism 59 and the side frame 510. Stay members 69b and 69b comprising grooves 691b and 691b which can engage with the support shafts 510d and 510d of the side frame 510 are attached to both ends of the connection frame 69a. Each of support plates 69c and 69c and fulcrum plates 69d and 69d on the inner side of the support plates 69c and 69c is connected to the connection frame 69a, on the inner side of the stay members 69b and 69b. A boss member 69e is attached and one end of the rod member 59i of the shift mechanism 59 is fixed slightly before the center of the connection frame 69a.

Arm members 69g and 69g having boss members at one end are provided between the support plates 69c and 69c and the fulcrum plates 69d and 69d. The boss member sides of the arm members 69g and 69g are rotatably connected to the support plates 69c and 69c and the fulcrum plates 69d and 69d. The other ends of the arm members 69g and 69g are rotatably connected to the fulcrum plates 68b and 68b of the second leg frame 68.

Next, a combination of each frame constituting the bottom unit 6 and the drive mechanism 5 will be explained.

In the back bottom 61, the boss members 61c and 61c are rotatably connected to the support plates 54c and 54c of the first support frame 54, similarly to the third link 58 of the drive mechanism 5. The slidable member 61f of the back bottom 61 is fitted in the bracket 58d and is slidably placed on the support roller 58e.

In this configuration, the back bottom 61 rotates as the third roller 58c of the third link 58 rolls on the upper surface of the cam plate 52d for back along with the operation of the cam mechanism 5A.

In the hip bottom 62, as described above, the support plates 62c and 62c are rotatably connected to the connection plates 61e and 61e of the back bottom 61, and the boss members 62d and 62d are attached to the support shafts 64c and 64c of the first knee frame 64. Furthermore, the fourth roller 62f is arranged so as to be capable of rolling on the upper surface of the cam plate 52c for hip.

As described above, the hip bottom 62, the knee bottom 63, and the leg bottom 66 are connected so as to be interlocked with one another. Both ends of the bottom connection rod 65g are attached to the fulcrum plate 65c of the second knee frame 65 and the support plate 57d of the second link 57, respectively, and the knee bottom 63 and the link unit 5C are thereby connected to each other.

Each of the components of the bed device 1 has been explained. Each component can be fixed with a pin or a screw, and special tools are unnecessary. For this reason, the bed device 1 can easily be assembled by one person.

Although not shown in the present embodiment, punching processing (drilling of long hole, square hole, and the like) may be executed on the component within the range which does not affect the function or the strength in order to reduce the weight of each component. The weight of the body can be thereby reduced.

In the present embodiment, since the bed device of the present invention is configured to allow each unit to be assembled, it can easily be installed in a room or the like.

In addition, in the present embodiment, the bottom unit is divided into four frames of the back bottom, the hip bottom, the knee bottom, and the leg bottom. However, the number of frames may be further increased such that the user's posture can easily be maintained.

Next, the operations of each component of the drive mechanism 5 and the bottom unit 6 at the time of posture change will be explained. It should be noted that components (base unit 2, elevating unit 3, mat 7, and the like) unnecessary for the explanations of operations are omitted in each drawing.

In the present embodiment, the drive mechanism 5 changes the posture of the bottom unit 6 of the supine posture, the back lifting posture, the sitting posture, and the rise assisting posture.

In the supine posture, for example, as shown in FIG. 13, the back bottom 61, the hip bottom 62, the knee bottom 63, and the leg bottom 66 are horizontally aligned. Each bottom is parallel to, for example, the placement surface of the bed device 1.

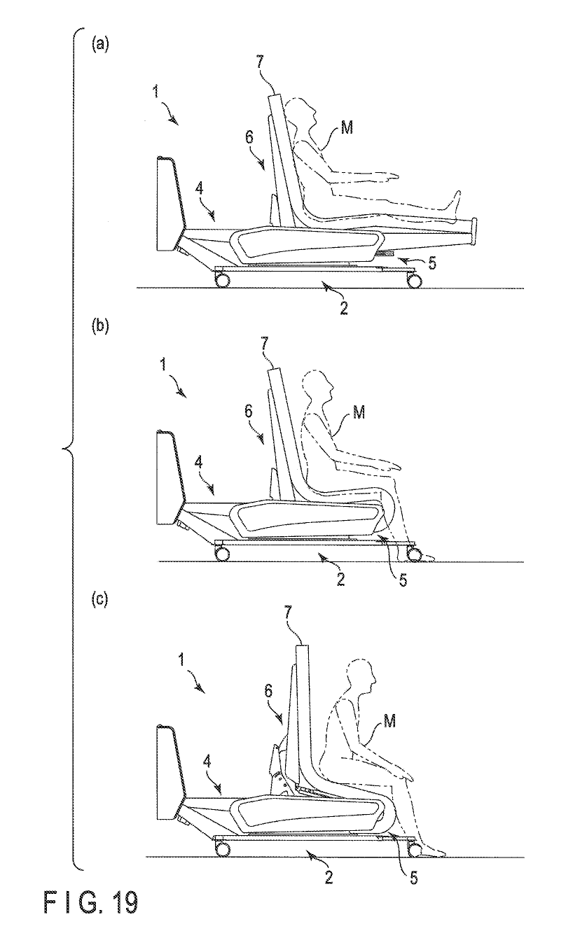

In the back lifting posture, as shown in FIG. 15 and FIG. 19(a), the back bottom 61 rises at a predetermined angle (for example, an obtuse angle) with respect to the hip bottom 62. For example, the hip bottom 62 gently tilts in the direction of the back bottom 61, and the leg bottom 66 (67 to 69) gently tilts in a direction opposite to the back bottom 61. That is, the hip bottom 62 and the leg bottom 66 form a predetermined angle (obtuse angle), and the knee bottom 63 rises. In this state, the connection portion between the hip bottom 62 and the knee bottom 63 (or the connection portion between the knee bottom 63 and the leg bottom 66) is located above the connection portion between the back bottom 61 and the hip bottom 62 (knee raising function).

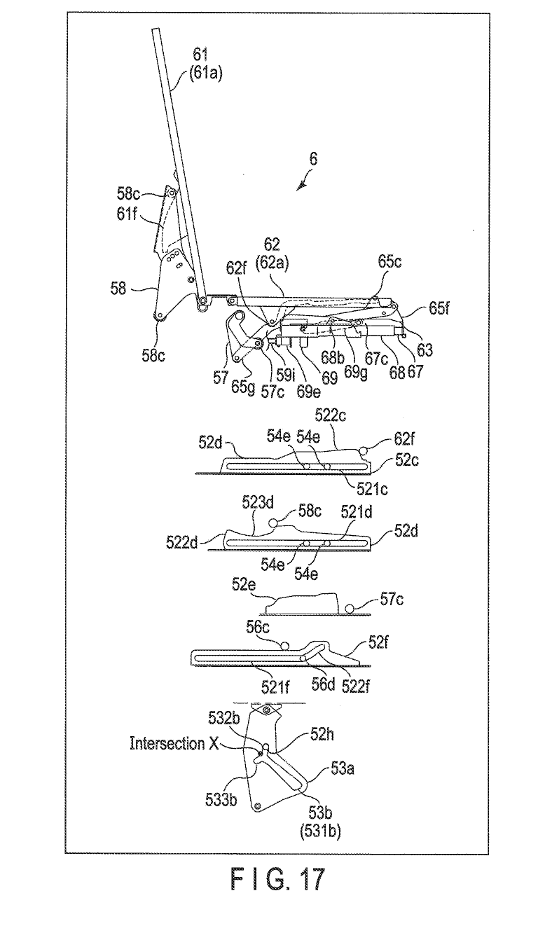

In the sitting posture, as shown in FIG. 17 and FIG. 19(b), the knee bottom 63 and the leg bottom 66 (67 to 69) are accommodated on the back side (lower side) of the hip bottom 62. The knee bottom 63 is accommodated in, for example, the leg bottom 66. For example, the hip bottom 62 and the leg bottom 66 are parallel to each other. The back bottom 61 stands up against the placement surface of the bed device 1 at an angle larger than, for example, an angle in the back lifting posture. The hip bottom 62 is, for example, parallel to the placement surface of the bed device 1 or inclined in the direction of the back bottom 61 at an angle smaller than an angle in the back lifting posture.

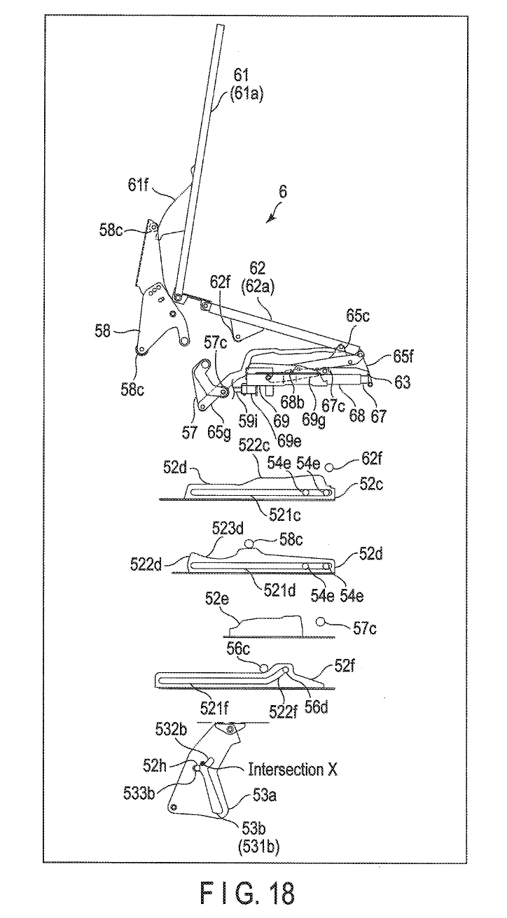

In the rise assisting posture, as shown in FIG. 18 and FIG. 19(b), the back bottom 61 is inclined toward the foot side (the right side in the drawing). For example, the angle formed between the upper surface of the back bottom 61 on which the mat 7 is placed and the placement surface of the bed device 1 is smaller than 90 degrees. The hip bottom 62 gently tilts towards the foot side of the bed device 1.

The above-explained outer frame 510a and inner frame 510c constitute a side rail which can freely extend and contract. The leg bottom 66 is pulled toward the head side of the bed device 1 according to the contraction of the side rails, and the leg bottom 66 is thereby accommodated on the back side of the hip bottom 62.

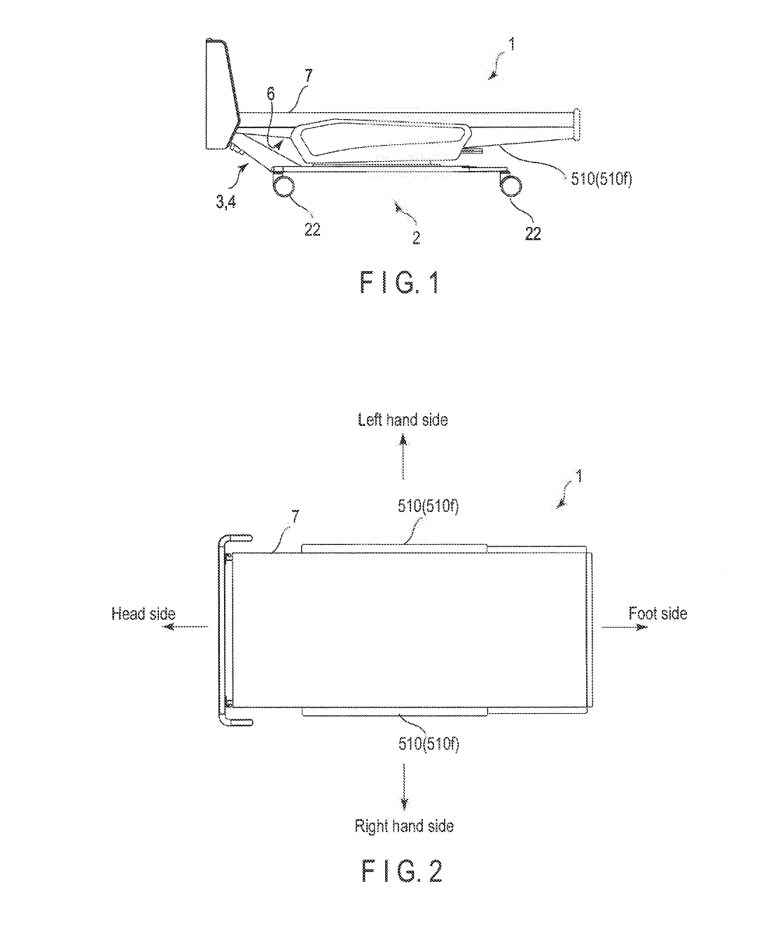

First, the change of posture from the supine posture shown in FIG. 1 to the back lifting posture will be explained with reference to FIG. 15 and FIG. 19(a).

The cam drive means 9 first contracts to the head side of the user M in response to the user M, the caregiver or the like operating a remote control switch (not shown). At this time, the first cam mechanism 52 connected to the cam drive means 9 starts moving toward the head side. Then, the third roller 58c of the third link 58 connected to the first cam mechanism 52 rolls from the lower end to the upper end of the arcuately curved side 522d of the cam plate 52d for back of the cam mechanism 52.

In addition to the rotation of the third link 58 from the head side to the foot side, the back bottom 61 also rotates from the head side to the foot side about the boss members 61c and 61c, and the posture is thereby changed to the back lifting posture.

At the same time, the second roller 57c of the second link 57 abuts against the cam plate 52e for knee and rolls on the upper surface, and the second link 57 thereby rotates from the foot side to the head side. At this time, the hip bottom 62 interlocking with the second link 57 also pivots from the foot side to the head side.

Furthermore, the bottom connection rod 65g connected to the second link 57 rotates from the foot side to the head side, simultaneously with the second link 57. Since the second knee frame 65 thereby acts so as to be drawn from the head side to the foot side, the second knee frame 65 rotates from the head side to the foot side about the fulcrum plates 65c and 65c, and the leg bottom 66 connected to the knee bottom 63 rotates similarly from the head side to the foot side.

The fourth roller 62f of the hip bottom 62 rolls on the upper surface 522c inclined to the upper right side, of the cam plate 52c for hip toward the foot side of the user M and supports the hip bottom 62. In addition, the first roller 56c of the first link 56 rolls on the upper surface of the cam plate 52f for erection to the foot side of the user M.

The leg bottom 66 is actuated, and the rod member 59i of the shift mechanism 59 connected to the boss member 69e of the third leg frame 69 is thereby pulled toward the head of the user M, and the shift mechanism 59 contracts. Then, the second cam mechanism 53 connected to the shift mechanism 59 also rotates from the foot side to the head side in a plan view with the support bracket 51c of the fixed frame 51 serving as the center of rotation.

At this time, the urging shaft 52h of the first cam mechanism 52 connected to the first cam mechanism 52 slides on the long side 531b of the Y-shaped groove 53b of the second base member 53a of the second cam mechanism 53 and moves from foot side to head side. At this time, however, the urging shaft 52h does not contact the intersection X of short sides 532b and 533b and a long side 531b of the Y-shaped groove 53b. In addition, the first rolling shafts 54e and 54e axially attached to the long holes 521c and 521d of the cam plate 52c for hip and the cam plate 52d for back so as to be rotatable from the head side to the foot side.

Although not shown, the limit switch 54f abuts against the upper surface of the switch support plate 52g when the posture is changed to the back lifting posture (i.e., the state in FIG. 15). The mode can be switched to the change of posture to the next sitting posture, instead of the switch button of the remote control switch (not shown). Therefore, a remote control switch (not shown) having a plurality of buttons does not need to be prepared.

By thus changing the posture from the supine posture (FIG. 1) to the back lifting posture (FIG. 15 and FIG. 19(a)), the back lifting and the knee lifting of the user M can be executed at the same time. The user M can be thereby prevented from slipping forward when lifting the back.

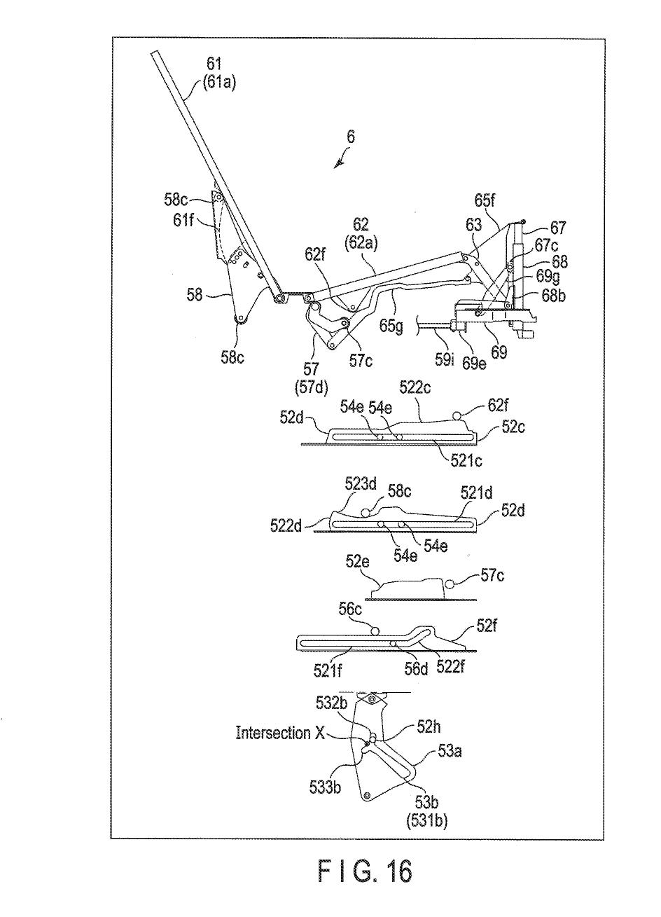

Next, the change of posture from the back lifting posture to the sitting posture will be explained with reference to FIG. 16, FIG. 17, and FIG. 19(b).

First, a state in which the posture is changed from the back lifting posture shown in FIG. 15 to the sitting posture is started will be explained.

The cam drive means 9 further contracts to the head side of the user M by the operation of the remote control switch (not shown). Then, the third roller 58c rolls on the arcuately curved side 523d of the back cam plate 52d. Then, as the third link 58 rotates slightly from the foot side to the head side, the back bottom 61 also rotates from the foot side to the head side about the boss members 61c and 61c and thereby slightly tilts backward from the back lifting posture.

At the same time, the second roller 57c of the second link 57 rolls toward the foot side of the user M up to the end of the side 521e, and the fourth roller of the hip bottom 62 also rolls on the upper surface 522c of the cam plate 52c for hip toward the foot side. Thus, the hip bottom 62 tilts slightly rearward, and the second knee frame 65 connected to the second link 57 is further operated so as to be pulled further from the head side to the foot side.

At this time, the leg bottom 66 is to rotate, but moves in the longitudinal direction from the foot side to the head side of the user M since the third leg frame 69 is attached to the side frame 510. Then, the fulcrum plates 67c and 67c of the first leg frame 67 serve as fulcrums, and the second leg frame 68 axially attached to the first leg frame 67 and the first leg frame 67 is rotated from the head side to the foot side. One-side ends of the first leg frame 67 and the second leg frame 68 thereby stand up.

At this time, a gap is generated between the second knee frame 65 and the first leg frame 67, but the mat 7, the user M, and the like are never caught since the cover 65f is provided. In addition, the urging shaft 52h of the first cam mechanism 52 reaches the intersection X of the Y-shaped grooves 53b of the second cam mechanism 53 and urges the second cam mechanism 53. At this time, since the second cam mechanism 53 rotates, the second cam mechanism 53 moves while urging the short side 532b side after the urging shaft 52h abuts on the intersection X. Then, in addition to the rotation of the second cam mechanism 53, the shift mechanism 59 contracts such that the inner frame 59c is accommodated in the outer frame 59a.

The state in which the posture is changing to the sitting posture is shown in FIG. 16. The movement of the first cam mechanism 52, the second cam mechanism 53, and the shift mechanism 59 is omitted since the movement is an extension of the operation at the time of starting the posture change, and the change of posture of the knee bottom 63 and the leg bottom 66 will be explained.

First, the leg bottom 66 will be explained.

As described above, since the third leg frame 69 is attached to the side frame 510, the third leg frame 69 moves in the longitudinal direction from the foot side to the head side of the user M without changing the posture. At this time, the second leg frame 68 axially attached to the third leg frame 69 so as to be rotatable by the arm member 69g, and the first leg frame 67 connected to the second leg frame 68 rotate from the head side to the foot side so as to be separated from the second knee frame 65 with the fulcrum plates 68b and 68b serving as the centers of rotation.

In this state, the first link 56 and the first roller 56c roll on the upper surface of the cam plate 52f for erection toward the foot side, and the abutment between the second roller 57c of the second link 57 and the knee cam plate 57e is canceled. Then, the third roller 58c of the third link 58 rolls on the upper surface 523d toward the foot side and the fourth roller 62f of the hip bottom 62 rolls on the upper surface of the cam plate 52c for hip toward the foot side.

Next, the operation to the sitting posture in the state in which the posture is changing to the sitting posture will be explained with reference to FIG. 17 and FIG. 19(b).

As described above, the cam mechanism 5A and the shift mechanism 59 move in the longitudinal direction from the foot side to the head side of the user M while contracting. Then, in accordance with the horizontal movement of the third leg frame 69, the first leg frame 67 and the second leg frame 68 move pivotally from the head side to the foot side about the fulcrum plates 68b, 68b serving as the centers of rotation. At this time, the first leg frame 67 moves so as to be drawn into the back side of the third leg frame 69 while being rotated by the arm member 69g. At the same time, the second leg frame 68 connected to the first leg frame 67 also moves while being rotated so as to be drawn into the back side of the third leg frame 69. Thus, the leg bottom 66 operates so as to be accommodated to the back side of the hip bottom 62 and the knee bottom 63 while being rotated.

In the accommodation of the leg bottom 66 to the back side of the hip bottom 62 and the knee bottom 63, the urging shaft 52h of the first cam mechanism 52 with respect to the second base member 53a of the second cam mechanism 53 is rotated while urging the second base member 53a from the short side 532b to the vicinity of the intersection X by the rotation of the second base member 53a.

In this state, the first roller 56c of the first link 56 rolls on the upper surface of the cam plate 52f for erection toward the foot side. The second roller 57c of the second link 57 is in a state in which the abutment on the knee cam plate 57e remains canceled. Then, the third roller 58c of the third link 58 reaches the end portion of the upper surface 523d, and the fourth hip bottom 62f of the hip bottom 62 rolls on the right-downward surface from the upper surface of the hip cam plate 52c to the foot side.

This state is the sitting posture (FIG. 17 and FIG. 19(b)). Thus, the cam mechanism 5A moves and a space is thereby generated on the back side (lower side) of the hip bottom 62 and the knee bottom 63. The bed device 1 in the sitting posture becomes compact by accommodating the leg bottom 66 in this space.

Lastly, the change of posture from the sitting posture to the rise assisting posture will be explained with reference to FIG. 18 and FIG. 19(c).

When the cam mechanism 5A further moves from the above-described sitting posture to the head side, the first roller 56c of the first link 56 thereby reaches the arcuately formed side 522f of the cam plate 52f for erection. In addition, the second rolling shaft 56d of the first link 56 also rolls through the long hole 521c of the cam plate 52c for hip, and rolls through an long hole 522c formed upwardly toward the foot side so as to be continuous with the long hole 521c.

Then, the first link 56 rotates from the foot side to the head side, the second support frame 55 axially attached to one end of the first link 56 rotates from the head side to the foot side, and the hip bottom 62 engaged with the second support frame 55 also rotates from the head side to the foot side, and the postures of the back bottom 61 and the hip bottom 62 are changed so as to be slightly inclined forward as shown in FIG. 18.

At this time, since the first knee frame 64 and the second knee frame 65 are axially attached so as to be rotatable, the first knee frame 64 rises in accordance with the rotation of the hip bottom 62. However, the postures of the second knee frame 65 and the leg bottom 66 are not changed.

By thus changing the posture to the sitting posture (FIG. 18 and FIG. 19(c)), the position of the buttocks changes to the half-rising posture at the rise when the user M rises from the bed device. Therefore, the user M can easily rise from the bed device.

The operation from the supine posture to the rise assisting posture has been explained. When the posture is changed from the rise assisting posture to the supine posture, each component is operated in the opposite direction.

Thus, in the bed device of the present embodiment, the change of posture from the back lifting posture of the bottom unit to the rise assisting posture can be implemented by one drive means (cam drive means 9). The bed device 1 can be thereby configured to be compact.

In addition, when the posture is changed from the supine posture to the back lifting posture, the user can be prevented from slipping forward by the knee raising function. Thus, the user's bed sores can be prevented and the pressure applied to the buttocks can be reduced.

Furthermore, when the back lifting posture is changed to the sitting posture, the leg bottom is stored on the back side of the hip bottom and the knee bottom. Thus, the user's foot can land on the floor surface in the sitting posture, and the user can safely rise from the bed device.

In the configuration of the present embodiment, since the height of the bed device can be made as low as possible, the degree of injury can be minimized even when the user accidentally falls down from the bed device. That is, the bed device can be used for safety of the user. For a caregiver as well, there is no need to worry about the user falling down from the bed device, which also has the effect of reducing the mental burden.

In addition, the user can easily rise from the bed device by changing the sitting posture to the rise assisting posture. Thus, the burden of assistance on a caregiver supporting the user can be reduced in addition to the physical burden on the user.

In addition, in the configuration of this bed device, the drive means for a series of operations is divided into the elevation drive means employed for elevation and the cam drive means employed for the change of posture of the bottom unit. Thus, elevation and the change of posture can be executed independently of each other. In other words, the posture of the bottom unit can be changed even if the upper frame unit is located at any elevation position. For example, since the height of the bottom unit is close to the floor surface at the lowest level, the posture can be changed in a state in which the user's hoot certainly touches the floor surface, and the user can hardly tumble or fall down.

In addition, when the posture of the seat is once changed to the sitting posture at the lowest level and then the upper frame unit is raised, the caregiver can allow the user to put on the shoes without losing the posture such as bending the hip. Then, the user can make the feet firmly touch the floor surface and rise by lowering the upper frame unit to the lowest level. In other words, the bed device of the present invention can attempt not only the user's safety but also the reduction of burden on the caregiver.

In addition, the cam mechanism is composed of the first cam mechanism and the second cam mechanism. The shift mechanism connected to the second cam mechanism can be operated by urging the second cam mechanism by the first cam mechanism composed of a plurality of cam plates operated by the cam drive means. That is, the driving force for operating the shift mechanism can be made unnecessary.

In addition, since the link unit axially attached to the support frame is configured to roll on the upper surfaces of the plurality of cam plates in accordance with the operation of the cam mechanism, the driving force for changing the posture of the bottom unit can be made unnecessary. Furthermore, load such as the weight of the bottom unit itself applied to the plurality of cam plates and the user's weight can be dispersed to the link unit and the support frame, by constituting the shaft member to roll in the long hole of the cam plate. The durability of the drive mechanism (first cam mechanism) can be thereby improved.

In addition, the shift mechanism is configured such that the total length in the extension is substantially double the length in the contraction. The driving force in changing the posture of the bottom unit from the supine posture to the sitting posture can be made unnecessary by connecting the shift mechanism to the leg bottom. In addition, since the knee bottom and the leg bottom can be pulled firmly into the back side of the hip bottom together with the side frame, the mat does not hang on the floor surface or touch the floor surface in the sitting posture.

The drive mechanism of the bed device can employ the cam drive means alone as the drive means employed in the change of posture. The bed device can be thereby configured to be compact.

In addition, the load such as the user's weight on the leg bottom is reduced by supporting the leg bottom with the side frame.

The change of posture using the knee bottom has been described, but the leg bottom may be axially attached directly to the hip bottom so as to be rotatable without using the knee bottom. In this case, the bed device can also be configured to rotate the tip of the leg bottom with one end on the hip bottom side serving as the center of rotation and to accommodate the leg bottom on the back side of the hip bottom.

At that time, the amount of rise of the tip of the bottom (leg bottom side) at the time of changing the posture from the back lifting posture to the rise assisting posture may be made larger than that at the time of using the knee bottom.

In addition, in the configuration of each bottom in the present embodiment, the posture can be changed with one mat as shown in FIG. 19 without preparing divided mats when the posture is changed from the back lifting posture to the sitting posture and the rise assisting posture. Therefore, the user does not have to worry about being caught in the gap between the bottoms at the time of changing the posture and can safely use the bed device.

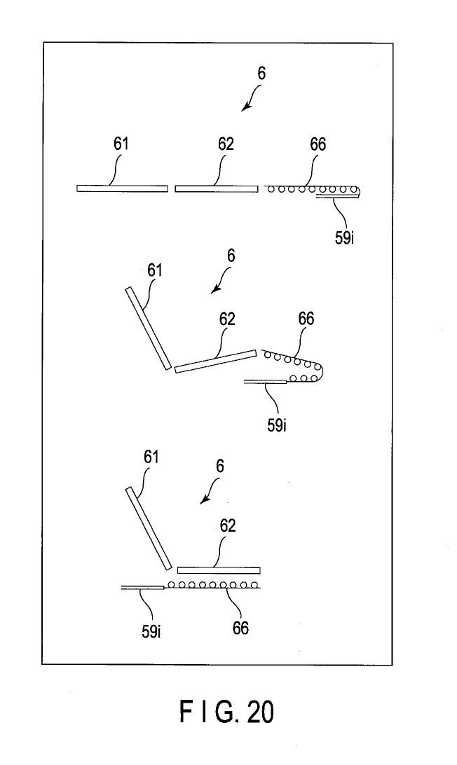

Next, another embodiment of accommodating the leg bottom on the back side of the hip bottom will be explained with reference to FIG. 20. Details of each component will be omitted.

In the present embodiment, a rod member 59i of a shift mechanism 59 is attached to one end of a leg bottom 66 molded into a roll type winding shutter. Then, as described above, when a drive mechanism 5 is operated such that the rod member 59i moves to the head side, the leg bottom 66 is attracted to the rod member 59i. The leg bottom 66 is accommodated on the back side of the hip bottom 62 while being reversed.

Thus, the posture can be changed to the sitting posture even in the configuration in which the knee bottom and the leg bottom are formed in a shutter shape. In addition to the leg bottom 66, the knee bottom 63 may be configured to be accommodated on the back side of the hip bottom 62.

Each of the embodiments discloses a configuration in which the change of posture of the bottom unit from the back lifting posture to the rise assisting posture is implemented by one drive means (cam drive means 9). However, the drive means for the change of posture may be provided separately.

Example of the bed device obtained from the present disclosure will be described below. The present disclosure is not limited to these examples, but various bed devices can be obtained according to the present disclosure.

[1] A bed device composed of a fixed frame firmly fixed on an upper frame unit which can be raised and lowered in the vertical direction by an elevating unit, a cam mechanism capable of moving in the longitudinal direction of the bed device in the fixed frame, a cam drive means for enabling the cam mechanism to be actuated by being fixed between the cam mechanism and the upper frame part and by extending and contracting, a support frame firmly fixed to the fixed frame, a link unit attached so as to be interlocked with the support frame and the cam mechanism, a drive unit constituted by a shift mechanism axially attached to the cam mechanism, and a bottom unit separately composed of at least a back bottom, a hip bottom, and a leg bottom arranged adjacent on the drive unit, wherein one end of the shift mechanism is firmly fixed to the foot side tip of the leg bottom, the cam mechanism is moved to the head side by operating the cam drive means, and the back bottom is thereby raised, the hip bottom and the leg bottom are subjected to knee lifting and the posture is changed from the supine posture to the back lifting posture, and when the operation of the cam drive means further progresses from the back lifting posture, the posture can be changed, irrespective of the elevation position of the upper frame unit, to the sitting posture in which the knee bottom and the leg bottom are rotatably housed to the back side of the hip bottom with the other end of the leg bottom serving as the center of rotation by attracting the leg bottom to the head side of the bed device by the shift mechanism.

[2] The bed device of [1], wherein the bottom unit further includes a knee bottom, the leg bottom is composed of a first leg frame to which one end of the knee bottom is firmly fixed, a second leg frame in which the first leg frame is slidably arranged, and a third leg frame to which the first leg frame and the second leg frame are axially attached so as to be rotatable and which is firmly fixed to one end of the shift mechanism to allow the cam mechanism to interlock in accordance with the movement of the bed device in the longitudinal direction, and when the posture is changed from the back lifting posture to the sitting posture, the knee bottom is accommodated in the first leg frame while rotating and the first leg frame is accommodated in the second leg frame while rotating about the third leg frame serving as the center of rotation while attracting the third leg frame of the leg bottom to the head side of the bed device by the shift mechanism, and the posture can be changed to the sitting posture in which the knee bottom and the leg bottom are accommodated on the back side of the hip bottom.

[3] The bed device of [2], wherein the cam mechanism is composed of a first cam mechanism supported so as to roll on the upper frame and configured to interlock with the bottom unit, and a second cam mechanism having one end axially attached to the fixed frame and the other end axially attached to the shift mechanism, and the second cam mechanism is made operable in accordance with an operation of the first cam mechanism by inserting an urging shaft of the first cam mechanism into a groove of the second cam mechanism.

[4] The bed device of [3], wherein a second roller axially attached to one end of a second link axially attached to the second support frame of the support frame so as to be rotatable allows a cam plate for knee of the first cam mechanism to roll, a third roller axially attached to one end of a third link of the link unit axially attached to a first support frame so as to be rotatable allows a cam plate for back of the first cam mechanism to roll, and a fourth roller of the hip bottom allows a cam plate for hip to roll.

[5] The bed device of any one of [1] to [4], wherein the shift mechanism axially attaches sprockets to respective vicinities of both ends in an inner frame slidably inserted into an outer frame, stretches a loop-shaped operation chain on the sprockets, firmly fixes a stay member and a rod member on the operation chain, firmly fixes the stay member to the outer frame and firmly fixes one end of the rod member to the third leg frame of the leg bottom, and the full length of the shift mechanism in the extension is substantially double the length in the contraction.

[6] The bed device of any one of [1] to [5], wherein when the contraction of the cam drive means proceeds from the sitting posture, a second rolling shaft axially attached to one end of a first link of the link unit which is axially attached to the first support frame of the support frame so as to be rotatable rolls in a long hole of a cam plate for erection of the first cam mechanism toward an upper position of the foot side, the first link is thereby rotated to the head side, and the back bottom and the hip bottom are rotated forward and upward about the knee serving as a center such that the posture can be changed to a rise assisting posture.

[7] The bed device of any one of [1] to [6], wherein a side rail configured such that an inner frame slides in an outer frame so as to extend and contract is capable of supporting the leg bottom and pulling the leg bottom in accordance with expansion and contraction of the shift mechanism, by supporting the outer frame at both right and left ends of the drive unit and firmly fixing one end of the inner frame to the leg bottom.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, manufacturing technology, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A bed device comprising:
a bottom unit including a back bottom, a hip bottom, and a leg bottom connected to one another; and
a drive mechanism capable of changing a posture of the bottom unit from a supine posture in which the back bottom, the hip bottom, and the leg bottom are aligned horizontally to a back lifting posture and a sitting posture,
wherein
the drive mechanism
allows the back bottom to stand up about the hip bottom in the change from the supine posture to the back lifting posture, and
rotates the leg bottom around one end of the hip bottom and accommodates the leg bottom on a back side of the hip bottom in the change from the back lifting posture to the sitting posture.

2. The bed device of claim 1, further comprising:
a side rail capable of extending and contracting, including an outer frame and an inner frame sliding inside the outer frame,
wherein
the leg bottom is pulled toward a head side of the bed device in accordance with the contraction of the side rail, and the leg bottom is thereby accommodated on the back side of the hip bottom.

3. The bed device of claim 1, wherein
the bottom unit further comprises a knee bottom arranged between the hip bottom and the leg bottom, and
the drive mechanism rotates the knee bottom and the leg bottom around one end of the hip bottom and accommodates the knee bottom and the leg bottom on the back side of the hip bottom, in the change from the back lifting posture to the sitting posture.

4. The bed device of claim 3, wherein
in the sitting posture, a connecting portion between the hip bottom and the knee bottom is located above a connecting portion between the back bottom and the hip bottom.

5. The bed device of claim 1, wherein
the drive mechanism is capable of changing a posture of the bottom unit from the sitting posture to the rise assisting posture, and tilts the back bottom and the hip bottom toward a foot side of the bed device in the change from the sitting posture to the rise assisting posture.
